(19) United States
(12) Patent Application Publication
(10) Pub. No.: US 2006/0044476 A1
(43) Pub. Date: Mar. 2, 2006

(54) Film mode detection apparatus and method thereof

(76) Inventors: Young-ho Lee, Yongin-si (KR); Seung-joon Yang, Seoul (KR)

Correspondence Address: STANZIONE & KIM, LLP, 919 18TH STREET, N.W., SUITE 440, WASHINGTON, DC, 20006, US

(21) Appl. No.: 11/210,823

(22) Filed: Aug. 25, 2005

(30) Foreign Application Priority Data
Aug. 26, 2004 (KR) 2004-67492

(51) Int. Cl. H04N 7/01

(52) U.S. Cl. 348/700; 348/441

(57) ABSTRACT

A film mode detection apparatus and a method thereof can determine whether an input image is a film image by detecting existence/nonexistence of a caption in an input image field and using information of the remaining area of a field except for a caption area. The apparatus includes a caption detection unit to detect minimum values of difference values of information between successive fields from a field area including a caption area and a remaining field area excluding the caption area in an input image, respectively, and to judge whether a caption exists in a present field according to variances of the detected minimum values, a pattern generation unit to generate a pattern of a certain area of the field using the difference values of the information between the successive fields according to whether the caption exists, and a decision unit to determine whether the input image is a film image using the generated pattern. Accordingly, deterioration of picture quality due to frequency on/off operation of a film mode caused by an error of film mode judgment can be prevented.

### CROSS-REFERENCE TO RELATED APPLICATIONS

This application claims benefit under 35 U.S.C. §119 from Korean Patent Application No. 2004-67492, filed on Aug. 26, 2004, the disclosure of which is incorporated herein in its entirety by reference.

### BACKGROUND OF THE INVENTION

1. Field of the Invention

The present general inventive concept relates to a film mode detection apparatus and a method thereof, and more particularly, to a film mode detection apparatus and a method thereof that can judge whether an input image is a film image by detecting existence/nonexistence of a caption area in an input image field and using information of a remaining area of the input image field excluding the caption area.

2. Description of the Related Art

Movies use a progressive system that processes an image at a speed of 24 sheets of pictures per second, instantaneously store every picture in a film and progressively project the pictures on a screen. In contrast, the image processing speed used by a television (TV) is different from that of the movies according to the color TV transmission system of the TV. In the NTSC (National Television System Committee) color TV system, 30 sheets of pictures per second are transmitted, and in the PAL (Phase Alternation by Line) system or SECAM (Sequential Couleur a Memoire) system, 25 sheets of pictures per second are transmitted. In the TV, since an image is basically transmitted over the air, each picture is filmed and transmitted through scanning of several hundreds of scanning lines, and then displayed on a screen of a Braun tube by scanning.

Additionally, the TV uses an interlaced scanning method that divides one picture (i.e., one frame) into two fields and alternately scans the two fields in order to effectively present a moving image using limited scanning lines. Accordingly, the NTSC system processes 60 fields of image per second, and the PAL or SECAM system processes 50 fields of image per second.

When a movie is televised through a TV, the picture speed must be adjusted. Since the number of pictures per second of the movie is different from that of the TV, they should be adjusted to correspond with each other. If the movie is reproduced through the TV without matching the number of pictures with that of the TV, the movie is displayed on the TV screen at a picture speed greater than a normal speed. In the case of transmitting the movie through the NTSC TV system, 60 fields must be obtained from 24 pictures (i.e., frames) per second, that is, two fields must be obtained from 2 pictures, in order to match the picture speed. Generally, a “3:2 pull-down” system, which scans three fields with respect to one picture, and scans two field with respect to the other picture, is used.

In the case of transmitting the movie through the PAL or SECAM TV system, 50 fields must be obtained from 25 pictures (i.e., frames) per second, that is, two fields must be obtained from each frame. This system, which scans two fields with respect to one field, is called a “2:2 pull-down” system.

FIG. 1 is a block diagram illustrating a conventional film mode detection apparatus.

Referring to FIG. 1, the conventional film mode detection apparatus includes a first field buffer 10, a second field buffer 20, a third field buffer 30, a calculation unit 40, an accumulation unit 50, a limiting unit 60, a band pass filter 70, a power calculation unit 80, and a mode detection unit 90.

The first field buffer 10, the second field buffer 20 and the third field buffer 30 sequentially store input image fields in the unit of a field. The calculation unit 40 calculates pixel value differences between the successive fields sequentially stored. The accumulation unit 50 obtains absolute values of the pixel value differences calculated by the calculation unit 40, and produces results of adding the values to all the pixels as intermediate data.

The limiting unit 60 performs a limiting operation in a manner that if the value calculated by the accumulation unit 50 is greater than a first threshold value, the limiting unit 60 replaces the calculated value by the first threshold value, since the value calculated by the accumulation unit 50 becomes quite large if trouble, such as a picture switchover, occurs. A sequence composed of the values calculated by the accumulation unit 50 and limited by the limiting unit 60 has a specified period, and the amplitude of the sequence moves within a specified limit.

The band pass filter 70 outputs a signal similar to a sine wave having a specified amplitude if the input waveform has a specified period, and outputs a value of approximately ‘0’ if the input waveform has no specified period.

The power calculation unit 80 calculates the power of the signal output from the band pass filter 70. Specifically, the power calculation unit 80 calculates a large power value with respect to the signal having the specified period, and calculates a power value of approximately ‘0’ with respect to the signal having no specified period.

The mode detection unit 90 compares the calculated power value with a predetermined second threshold value. If the calculated power value is greater than the second threshold value, the mode detection unit 90 judges that the input image is a film image and turns on a film mode. If the calculated power value is less than the second threshold value, the mode detection unit 90 judges that the input image is not the film image and turns off the film mode.

The conventional film mode detection apparatus as described above judges whether the input image corresponds to the film mode using the difference values of information between fields in the whole field area between the successive fields. However, if a caption is included in the field, the difference value of the information between the fields calculated by the calculation unit 40 is quite different from the difference value of the information of the fields in which no caption is included. This may cause an error to occur when the mode detection unit 90 judges whether the input image corresponds to the film mode according to the calculated values calculated through the calculation unit 40, accumulation unit 50, limiting unit 60, band pass filter 70, and power calculation unit 80.

Additionally, due to frequency on/off operation of the film mode caused by the error of film mode judgment, the picture quality deteriorates.

### SUMMARY OF THE INVENTION

The present general inventive concept provides a film mode detection apparatus and a method thereof that can prevent an error of film mode judgment by judging whether an input image is a film image using field difference information of a field area that excludes a caption area.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a film mode detection apparatus including a caption detection unit to detect minimum values of difference values of information between successive fields from a field area that includes a caption area and a remaining field area that excludes the caption area in an input image, respectively, and to judge whether a caption exists in a present field according to variances of the detected minimum values, a pattern generation unit to generate a pattern of a certain area of the field using the difference values of the information between the successive fields according to a result of judgment performed by the caption detection unit, and a decision unit to determine whether the input image is a film image using the pattern generated by the pattern generation unit.

The difference value of the information between the fields may be one of a difference value between pixel values, a difference value between SAD (Sum of Absolute Difference) values, and a difference value between judder amounts.

The caption detection unit may include a judder detection unit to detect judder of the field from the input image, a first judder counter to measure an amount of judder between a first field and a second field and an amount of judder between the second field and a third field in a first area of the fields, a second judder counter to measure an amount of judder between the first field and the second field and an amount of judder between the second field and the third field in a second area of the fields, a first minimum value detection unit to detect first minimum values of the amount of judder measured by the first judder counter, a second minimum value detection unit to detect second minimum values of the amount of judder measured by the second judder counter, a first operation unit to calculate a first variance of the first minimum values detected by the first minimum value detection unit, a second operation unit to calculate a second of the second minimum values detected by the second minimum value detection unit and a judgment unit to judge whether the caption exists in the second field by comparing the first variance calculated by the first operation unit with the second variation calculated by the second operation unit.

The caption detection unit may further include a first buffer to store the first minimum values detected by the first minimum value detection unit and a second buffer to store the second minimum values detected by the second minimum value detection unit.

The caption detection unit may further include a caption area detection unit to detect a caption area among areas of the fields according to the judder detected by the judder detection unit.

The first area may include one of a whole field area including the caption area and the caption area of the fields, and the second area may include a remaining field area excluding the caption area of the fields. The first and second variance may be one of an average, a standard deviation, and a dispersion of the respective first and second minimum values.

If the difference between the first variance and the second variance is greater than a predetermined value, the judgment unit judges that the caption exists in the field.

The pattern generation unit may generate the pattern in the remaining area excluding the caption area of the field if the caption is detected by the caption detection unit, and may generate the pattern in the whole area of the field if the caption is not detected by the caption detection unit.

The foregoing and/or other aspects of the present general inventive concept are also achieved by providing a film mode detection apparatus, including a caption detection unit to detect minimum values of difference values of information between successive fields from a field area that includes a caption area and a remaining field area that excludes the caption area in an input image, respectively, and to judge whether a caption exists in a field according to variances of the detected minimum values, a pattern generation unit to generate a pattern in a whole area of the field and by specified areas of the field using the difference values of the information between the successive fields, and a decision unit to determine whether the input image is a film image using one of the patterns generated by the pattern generation unit according to a result of the judgment performed by the caption detection unit.

The decision unit may use a pattern generated in the remaining field area excluding the caption area if the caption is detected by the caption detection unit, and may use the pattern generated in the whole area of the field if the caption is not detected by the caption detection unit.

The foregoing and/or other aspects of the present general inventive concept are also achieved by providing a film mode detection apparatus, including a caption detection unit to determine whether a caption exists in fields of an input image, and a film image detection unit to determine whether the input image is a film image using a non-caption area of the fields of the input image not including the caption when the caption detection unit determines that the caption exists and using a total area of the fields of the input image when the caption detection unit determines that the caption does not exist.

The foregoing and/or other aspects of the present general inventive concept are also achieved by providing a film mode detection method, including detecting judder of fields of an input image, measuring an amount of judder between a first field and a second field and an amount of judder between the second field and a third field in a first area and a second area of the fields, respectively, detecting first minimum values of the amount of judder measured in the first area and second minimum values of the amount of judder measured in the second area, calculating a first variance of the first minimum values and a second variance of the second minimum values, judging whether a caption exists in the second field by comparing the first variance with the second variance, generating a pattern using difference values of information between the successive fields according to whether the caption exists, and judging whether the input image is a film image using the generated pattern.

The first area may include one of a whole field area including a caption area and the caption area, and the second area may include a remaining field area excluding the caption area. The first variance and the second variance may be any one of an average, a standard deviation, and a dispersion of the first minimum values and the second minimum values, respectively, and if the difference between the first variance and the second variance is larger than a predetermined value, it is judged that the caption exists in the second field.

The generating of the pattern using the difference values of the information between the successive fields may include generating the pattern in the remaining field area excluding the caption area if the caption is judged to exist, and generating the pattern in the whole area of the field if the caption is judged not to exist.

The film mode detection method may further include detecting the caption area using the detected judder.

The detecting of the caption area may include detecting a specified area as the caption area if the detected judder is greater than a predetermined value in the specified area of the fields.

The foregoing and/or other aspects of the present general inventive concept are also achieved by providing a film mode detection method, including detecting judder of fields of an input image, measuring an amount of judder between a first field and a second field and an amount of judder between the second field and a third field in a first area and a second area of the fields, respectively, detecting first minimum values of the amount of judder measured in the first area and second minimum values of the amount of judder measured in the second area, calculating a first variance of the first minimum values and a second variance of the second minimum values, judging whether a caption exists in the second field by comparing the first variance with the second variance, generating a pattern in a whole area of the field and by specified areas of the field using difference values of information between the successive fields, and judging whether the input image is a film image using one of the generated patterns according to whether the caption is judged to exist.

The judging of whether the input image is the film image may include using a pattern generated in a remaining area excluding a caption area if the caption is judged to exist, and using the pattern generated in the whole area of the field if the caption is judged not to exist.

The foregoing and/or other aspects of the present general inventive concept are also achieved by providing a film mode detection method, including determining whether a caption exists in fields of an input image, generating a pattern according to difference values between successive fields of the input image in a non-caption area of the successive fields not including the caption when the caption is determined to exist and generating a pattern according to difference values between successive fields of the input image in a total area of the successive fields when the caption is determined not to exist, and determining whether the input image is a film image according to the generated pattern.

The foregoing and/or other aspects of the present general inventive concept are also achieved by providing a film mode detection method, including determining whether a caption exists in fields of an input image, generating a plurality of patterns according to difference values between successive fields of the input image using a plurality of different areas of the successive fields, selecting one of the plurality of patterns corresponding to a non-caption area of the successive fields not including the caption when the caption is determined to exist and selecting one of the plurality of patterns corresponding to a total area of the successive fields when the caption is determined not to exist, and determining whether the input image is the film image according to the selected pattern.

The foregoing and/or other aspects of the present general inventive concept are also achieved by providing a film mode detection method, including determining whether a caption exists in fields of an input image, and determining whether the input image is a film image using a non-caption area of the fields of the input image not including the caption when the caption is determined to exist and using a total area of the fields of the input image when the caption is determined not to exist.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional film mode detection apparatus;

FIG. 2 is a block diagram illustrating a film mode detection apparatus according to an embodiment of the present general inventive concept;

FIG. 3 is a block diagram illustrating a caption detection unit of the film mode detection apparatus of FIG. 2 according to an embodiment of the present general inventive concept;

FIG. 4 is a block diagram illustrating a caption detection unit of the film mode detection apparatus of FIG. 2 according to another embodiment of the present general inventive concept;

FIGS. 5a and 5b are views illustrating a variance difference between an area including a caption and a remaining area excluding the caption;

FIG. 6 is a block diagram illustrating a decision unit using a result of caption detection in a film mode detection apparatus according to another embodiment of the present general inventive concept; and

FIG. 7 is a flowchart illustrating a film mode detecting method according to an embodiment of the present general inventive concept.

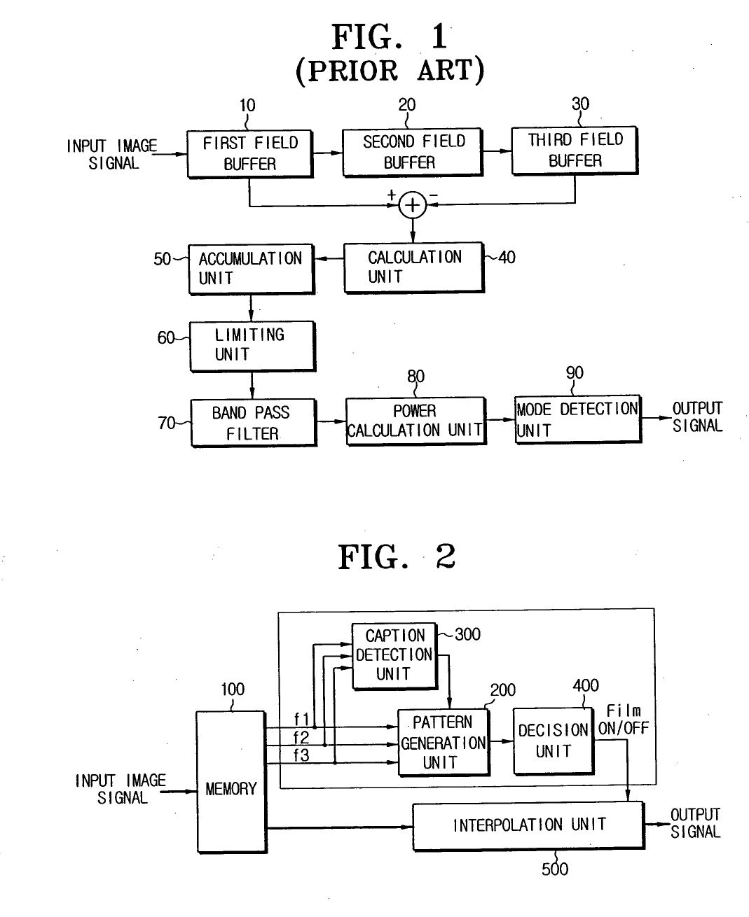

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 2 is a block diagram illustrating a film mode detection apparatus according to an embodiment of the present general inventive concept.

Referring to FIG. 2, the film mode detection apparatus according to the present embodiment includes a memory 100, a pattern generation unit 200, a caption detection unit 300, and a decision unit 400.

The memory 100 stores fields of an input image signal.

The caption detection unit 300 detects whether a caption exists in each field by calculating difference values of information between successive fields sequentially input in a first area and a second area of the successive fields and comparing variances of the calculated difference values of the information between the successive fields. That is, the caption detection unit 300 detects first difference values between the successive fields in the first area of the successive fields, detects second difference values between the successive fields in the second area of the successive fields, and compares variances of the calculated first and second difference values. The first area can be a predetermined portion of the fields, such as a top portion or a bottom portion of the fields, in which a caption is likely to be disposed. The first area can alternatively be a total portion of the fields including the predetermined portion of the fields. The second area can be a remaining portion of the fields excluding the predetermined portion. The result of detection performed by the caption detection unit 300 is output to the pattern generation unit 200. The difference values of the information between the successive fields may be pixel value differences between the fields, differences between judder amounts, differences between SADs (Sum of Absolute Differences), etc.

The pattern generation unit 200 generates a pattern by obtaining SAD values between the successive fields stored in the memory 100. That is, the pattern generation unit 200 generates the pattern by calculating an SAD value between a previous field previous to a present field and the present field and an SAD value between the present field and a next field after the present field, comparing the calculated SAD values with a specified threshold value, and generating a ‘1’ if the SAD value is greater than or equal to the specified threshold value while generating a ‘0’ if the SAD value is less than the specified threshold value. The pattern generation unit 200 may generate the pattern of a specified area of the fields by calculating the SAD values in the specified area, or may generate the pattern by calculating the SAD value in the whole field area.

If the caption detection unit 300 detects the caption, the pattern generation unit 200 generates the pattern using the difference values of the information between the fields in a remaining field area excluding the caption area where the caption is detected. However, if the caption detection unit 300 detects no caption, the pattern generation unit 200 generates the pattern using the difference values of the information between the fields in the whole field.

The decision unit 400 decides that the input image is a film image if the pattern generated by the pattern generation unit 200 is equal to a predetermined film image pattern. In contrast, if the pattern generated by the pattern generation unit 200 is different from the predetermined film image pattern, the decision unit 400 decides that the input image is not the film image.

An output signal of the decision unit 400 is input to an interpolation unit 500. The interpolation unit 500 performs an interpolation of the image using information of the successive fields if the input image corresponds to the film mode. If the input image does not correspond to the film mode, the interpolation unit 500 performs interpolation without using the information of the successive fields.

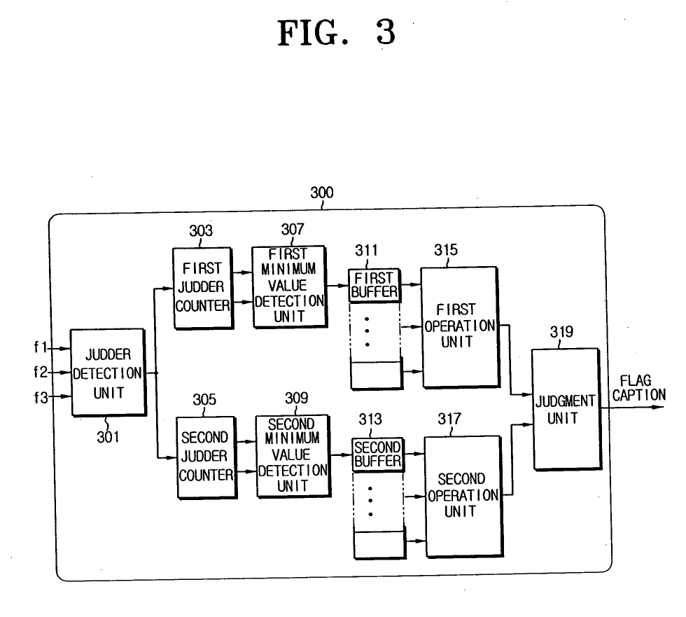

FIG. 3 is a block diagram illustrating a construction of the caption detection unit 300 of the film mode detection apparatus of FIG. 2 according to an embodiment of the present general inventive concept.

Referring to FIG. 3, the caption detection unit 300 according to the present embodiment includes a judder detection unit 301, a first judder counter 303, a second judder counter 305, a first minimum value detection unit 307, a second minimum value detection unit 309, a first buffer 311, a second buffer 313, a first operation unit 315, a second operation unit 317 and a judgment unit 319.

The judder detection unit 301 detects judder in the successive fields stored in the memory 100.

The first judder counter 303 and the second judder counter 305 each calculate an amount of judder by measuring the judder detected by the judder detection unit 301. The first judder counter 303 and the second judder counter 305 have different field areas in which the respective amounts of judder are calculated. The first judder counter 303 measures the amount of judder in the whole field area that may include a caption area and a remaining area, and the second judder counter 305 measures the amount of judder in the remaining field area that excludes the caption area. Alternatively, the first judder counter 303 may measure the amount of judder in the caption area, and the second judder counter 305 may measure the amount of judder in the remaining area that excludes the caption area. Here, since the caption is generally located on an upper or lower part of the field, the upper or lower part of the field is determined as the caption area.

For example, the first judder counter 303 can measure the amount of judder between a first field f1 and a second field f2 and the amount of judder between the second field f2 and a third field f3 in the whole field area. The second judder counter 305 can measure the amount of judder between the first field f1 and the second field f2 and the amount of judder between the second field f2 and the third field f3 in the remaining field area that excludes the caption area.

Hereinafter, it is exemplified that the first judder counter 303 measures the amount of judder in the whole field area that includes the caption area, and the second judder counter 305 measures the amount of judder in the remaining field area that excludes the caption area.

The first minimum value detection unit 307 detects first minimum values among the amounts of judder measured by the first judder counter 303, and the second minimum value detection unit 309 detects second minimum values among the amounts of judder measured by the second judder counter 305. That is, the first minimum value detection unit 307 detects a minimum value of the amounts of judder between the first field f1 and the second field f2 and detects a minimum value of the amounts of judder between the second field f2 and the third field f3 measured by the first judder counter 303 in the whole field area that includes the caption area.

The second minimum value detection unit 309 detects a minimum value of the amounts of judder between the first field f1 and the second field f2 and detects a minimum value of the amounts of judder between the second field f2 and the third field f3 measured by the second judder counter 305 in the remaining field area that excludes the caption area.

The first buffer 311 and the second buffer 313 store the first and second minimum values detected by the first minimum value detection unit 307 and the second minimum value detection unit 309, respectively.

The first operation unit 315 and the second operation unit 317 calculate variances of the first and second minimum values stored in the first buffer 311 and the second buffer 313, respectively. That is, the first operation unit 315 calculates a first variance of the first minimum values of the amounts of judder between the successive fields in the whole area that includes the caption area stored in the first buffer 311. The second operation unit 317 calculates a second variance of the second minimum values of the amounts of judder between the successive fields in the remaining area that excludes the caption area stored in the second buffer 313. Here, the variance may be an average, a standard deviation, a dispersion, etc., of the minimum values.

The judgment unit 319 judges whether the caption exists in the fields by comparing the respective first and second variances calculated by the first operation unit 315 and the second operation unit 317. If a difference between the first variance calculated by the first operation unit 315 and the second variance calculated by the second operation unit is greater than a predetermined value, the judgment unit 319 judges that a caption exists in the fields. That is, if there is a difference between the first variance of the first minimum values of the amounts of judder of the area that includes the caption area and the second variance of the second minimum values of the amounts of judder of the remaining area that excludes the caption area, the decision unit 310 decides that the caption exists in the fields.

Since the amount of judder in the area that includes the caption is relatively greater than the amount of judder in the area that excludes the caption, if the first variance of the first minimum values of the amounts of judder in the area that includes the caption is quite greater than the second variance of the minimum values of the amounts of judder in the area that excludes the caption, it can be judged that the caption exists in the fields.

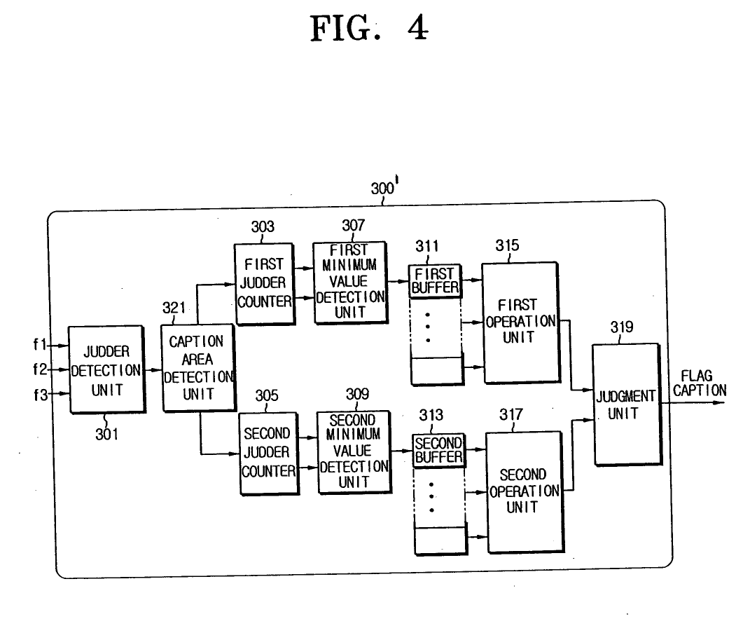

FIG. 4 is a block diagram illustrating a construction of the caption detection unit 300 of the film mode detection apparatus of FIG. 2 according to another embodiment of the present general inventive concept. The caption detection unit 300′ of FIG. 4 detects the existence/nonexistence of a caption by adaptively changing a caption area according to a judder map, and is provided with a caption area detection unit 321 in addition to the construction of the caption detection unit 300 of FIG. 3.

Referring to FIG. 4, the caption area detection unit 321 detects the caption area according to the judder of the field detected by the judder detection unit 310. The caption area detection unit 321 detects an area where a maximum amount of judder is detected in the field area as the caption area, and determines the areas in which the first judder counter 303 and the second judder counter 305 measure the amounts of judder. The caption area is not preset by determining the upper or lower area of the field as the caption area, as illustrated in the embodiment of FIG. 3, but is set by detecting the caption area according to the judder detected by the judder detection unit 301 before measuring the amounts of judder and applying the detected caption area when measuring the amounts of judder. Accordingly, the caption detection unit 300′ of the present embodiment can accurately detect the existence/nonexistence of the caption even in the case in which the caption exists in an area of the field other than the upper or lower area.

For example, if the caption area is determined to exist in the center of the field as a result of the detection performed by the caption area detection unit 321, the first judder counter 303 measures the amount of judder in the whole field area that includes the caption area, and the second judder counter 305 counts the amount of judder in the remaining area that excludes the caption area.

The operations of other constituent elements of the caption detection unit 300′ of FIG. 4, such as the judder detection unit 301, first judder counter 303, second judder counter 305, first minimum value detection unit 307, second minimum value detection unit 309, first buffer 300, second buffer 313, first operation unit 315, second operation unit 317, and judgment unit 319 are substantially the same as those of the caption detection unit 300 of FIG. 3.

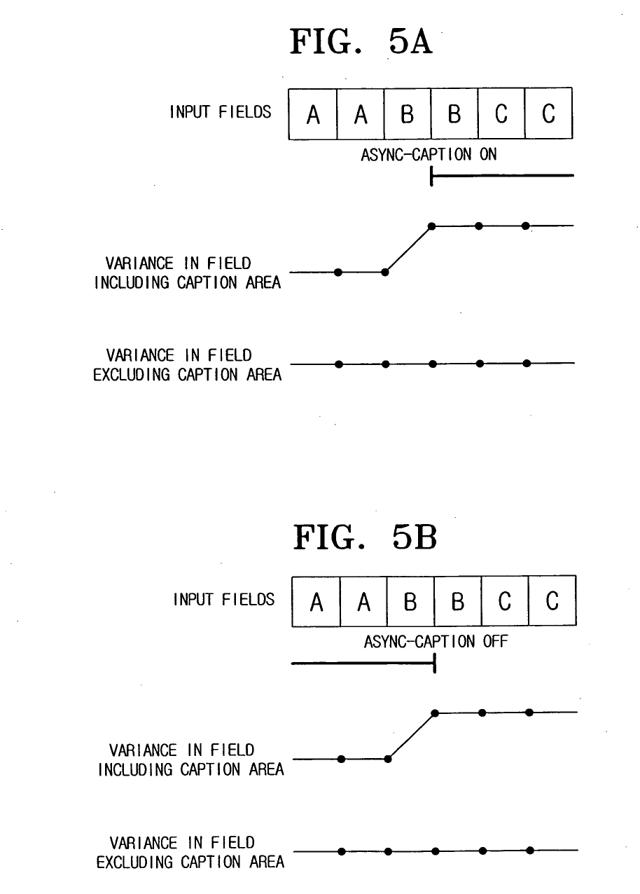

FIGS. 5A and 5B are views illustrating the variance difference between the area including the caption and the remaining area excluding the caption.

Referring to FIG. 5A, when comparing the variance in the whole field area that includes the caption area with the variance in the remaining area that excludes the caption area, it can be seen that the difference between the variances in input field B is large. That is, since the variance in the whole field area that includes the caption area is greater than the variance in the remaining field area that excludes the caption area, it can be judged that the caption exists in the field B.

Referring to FIG. 5B, when comparing the variance in the whole field area that includes the caption area with the variance in the remaining area that excludes the caption area, it can be seen that the difference between the variances in the input field B is large. However, since the variance in the whole field area that includes the caption area is substantially equal to the variance in the remaining field area that excludes the caption area before the field B, it can be judged that no caption exists in the field previous to the field B. The judgment of the existence/nonexistence of the caption in the field by comparing the variance in the whole field area that includes the caption area with the variance in the remaining area that excludes the caption area is performed by the judgment unit 319. The result of judgment of the existence/nonexistence of the caption is output to the decision unit 400 or the pattern generation unit 200.

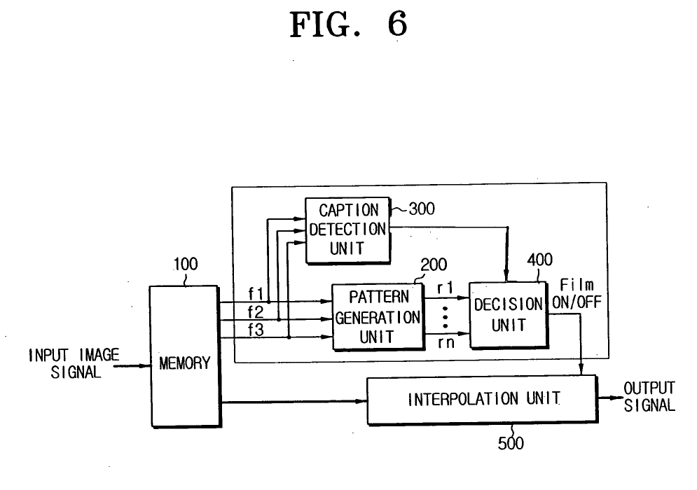

FIG. 6 is a block diagram illustrating that the result of caption detection is used in the decision unit 400 in a film mode detection apparatus according to another embodiment of the present general inventive concept.

Referring to FIG. 6, the result of caption detection performed by the caption detection unit 300 is output to the decision unit 400. The pattern generating unit 200 generates a plurality of patterns r1 to rn using the whole field area and one or more specified areas of the fields. The decision unit 400 decides whether the input image is the film image according to one of the patterns r1 to rn generated by the pattern generating unit 200 and the result of caption detection performed by the caption detection unit 300. That is, if the caption detection unit 300 judges that the caption exists in the specified area of the fields, the decision unit 400 decides whether the input image is the film image using the pattern generated in the field area that excludes the caption area among the patterns r1 to rn generated by the pattern generation unit 200.

In contrast, if the caption detection unit 300 judges that the caption does not exist in the fields, the decision unit 400 decides whether the input image is the film image using the pattern generated in the whole field area by the pattern generation unit 200. Accordingly, the decision unit 400 prevents a possible error of film mode judgment by judging whether the input image is the film image using the difference value of the information between the successive fields in the whole field that includes the caption area if the caption exists.

For example, if the pattern generation unit 200 generates the pattern using the difference values of the information between the successive fields in the whole field area in which the caption exists although the input image is the film image, the input image comes to have a pattern different from the film image, and thus an error may occur in judging whether the input image is the film image. That is, since the difference values of the information between the successive fields in the whole field area in which the caption exists is greater than the difference values of the information between the successive fields in the remaining field area that excludes the caption area, the pattern generated from the pattern generation unit 200 may be different from the pattern of the film image.

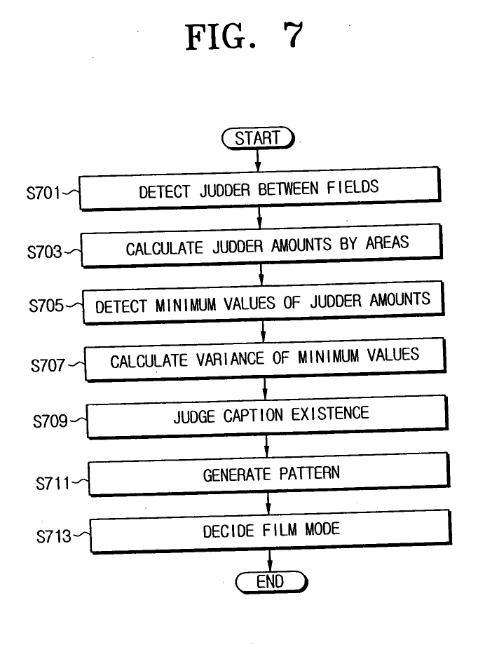

FIG. 7 is a flowchart illustrating a film mode detecting method according to an embodiment of the present general inventive concept. In this embodiment, whether the input image is a film image is determined by detecting the caption using the variance of the minimum values of the amounts of judder between the successive fields. However, it is also possible to determine whether the input image is a film image by detecting the caption using the difference values of the information between different fields, such as pixel values, SAD values, etc., between the successive fields.

Referring to FIG. 7, the judder detection unit 301 detects the judder between the input successive fields (operation S701).

The first judder counter 303 and the second judder counter 305 then calculate the amounts of judder in the whole field area that includes the caption area and in the remaining field area that excludes the caption area, respectively (operation S703).Alternatively, the first judder detection unit 303 and the second judder detection unit 305 may calculate the amounts of judder in the caption area and in the remaining field area that excludes the caption area, respectively. The caption area may be preset to an upper or lower part of the fields, or may be detected using the result of detection performed by the judder detection unit 310 to determined the areas in which the first judder counter 303 and the second judder counter 305 measure the amounts of judder.

The first minimum value detection unit 307 and the second minimum value detection unit 309 detect the first and second minimum values among the amounts of judder counted by the first judder counter 303 and the second judder counter 305, respectively (operation S705). That is, the first minimum value detection unit 307 detects the minimum value of the amounts of judder between the first field and the second field and detects the minimum value of the amounts of judder between the second field and the third field measured by the first judder counter 303 in the whole field area that includes the caption area. The second minimum value detection unit 309 detects the minimum value of the amounts of judder between the first field and the second field and detects the minimum value of the amounts of judder between the second field and the third field measured by the second judder counter 305 in the remaining field area that excludes the caption area.

The first operation unit 315 and the second operation unit 317 then calculate the first and second variances of the first and second minimum values detected by the first minimum value detection unit 307 and the second minimum value detection unit 309, respectively (operation S707). Here, the first and second variances may be an average, a standard deviation, a dispersion, etc., of the first and second minimum values, respectively. The first operation unit 315 and the second operation unit 317 calculate the first and second variances using the first and second minimum values respectively stored in the first buffer 311 and the second buffer 313.

The judgment unit 319 judges whether the caption exists in the fields by comparing the respective first and second variances calculated by the first operation unit 315 and the second operation unit 317 (operation S709). If the difference between the first and second variances calculated by the first operation unit 315 and the second operation unit 317 is greater than the predetermined value, the judgment unit 319 judges that the caption exists in the fields. If the caption area exists in the fields, a relatively large amount of judder is detected in the caption area in comparison to the remaining area that excludes the caption area.

Accordingly, if the caption exists in the fields, there is a difference between the first variance of the first minimum values of the amounts of judder calculated in the whole field area that includes the caption area and the second variance of the second minimum values of the amounts of the judder calculated in the remaining area that excludes the caption area.

The pattern generation unit 200 then generates the pattern in the specified field area according to the existence/nonexistence of the caption detected by the caption detection unit 300 (operation S711). That is, if the caption detection unit 300 detects the caption, the pattern generation unit 200 generates the pattern using the difference values of the information of the successive fields in the remaining area excluding the caption area. However, if the caption detection unit 300 detects no caption, the pattern generation unit 200 generates the pattern using the difference values of the information of the successive fields in the whole field area. Accordingly, an error that may occur when the pattern is generated using the difference values of the information between the successive fields in the field area that includes the caption area due to the relatively large amount of judder included in the caption area is prevented.

The decision unit 400 decides whether the input image is the film image according to the pattern generated by the pattern generation unit 200 (operation S713). That is, if the pattern generated by the pattern generation unit 200 is equal to the predetermined film image pattern, the decision unit 400 decides that the input image is the film image, while if the pattern generated by the pattern generation unit 200 is different from the predetermined film image pattern, the decision unit 400 decides that the input image is not the film image.

In the embodiment of FIG. 7, it is exemplified that the pattern generation unit 200 generates the pattern using the result of caption detection performed by the caption detection unit 300 and the decision unit 400 decides whether the input image is the film image according to the pattern generated from the pattern generation unit 200. However, as described above in the embodiment of FIG. 6, the decision unit 400 may determine whether the input image is the film image using the result of caption detection performed by the caption detection unit 300 after the pattern generation unit 200 generates the plurality of patterns irrespective of the result of caption detection performed by the caption detection unit 300.

That is, if the caption detection unit 300 detects the caption after the pattern generation unit 200 generates the plurality of patterns in the whole field and one or more specified areas of the field, the decision unit 400 may determine whether the input image is the film image using the pattern generated in the remaining area that excludes the caption area among the patterns generated by the pattern generation unit 200. However, if the caption detection unit 300 does not detect the caption, the decision unit 400 decides whether the input image is the film image using the pattern generated in the whole field area among the patterns generated by the pattern generation unit 200.

In the case in which the pattern generation unit 200 receives the result of caption detection performed by the caption detection unit 300, the pattern generation unit 200 generates the pattern using the difference values of the information between the fields according to the received result. However, in the case in which the decision unit 400 receives the result of caption detection performed by the caption detection unit 300, the decision unit 400 selects one of the patterns generated in the pattern generating unit 200 according to the received result and decides whether the input image corresponds to the film mode using the selected pattern.

As described above, according to the embodiments of the present general inventive concept, a film mode is determined using difference values of information between successive fields in a remaining field area that excludes a caption area, and thus an error of film mode judgment due to the existence of a caption in the fields can be prevented. Accordingly, deterioration of picture quality due to frequency on/off operation of the film mode caused by the error of film mode judgment can also be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A film mode detection apparatus comprising:
a caption detection unit to detect minimum values of difference values of information between successive fields from a field area that includes a caption area and a remaining field area that excludes the caption area in an input image, respectively, and to judge whether a caption exists in a present field according to variances of the detected minimum values;
a pattern generation unit to generate a pattern of a certain area of the field using the difference values of the information between the successive fields according to a result of judgment performed by the caption detection unit; and
a decision unit to determine whether the input image is a film image using the pattern generated by the pattern generation unit.

2. The film mode detection apparatus as claimed in claim 1, wherein the difference value of the information between the fields comprises one of a difference value between pixel values, a difference value between SAD (Sum of Absolute Difference) values, and a difference value between judder amounts.

3. The film mode detection apparatus as claimed in claim 1, wherein the caption detection unit comprises:
a judder detection unit to detect judder of each field from the input image;
a first judder counter to measure an amount of judder between a first field and a second field and an amount of judder between the second field and a third field in a first area of the fields;
a second judder counter to measure an amount of judder between the first field and the second field and an amount of judder between the second field and the third field in a second area of the fields;
a first minimum value detection unit to detect first minimum values of the amount of judder measured by the first judder counter;
a second minimum value detection unit to detect second minimum values of the amount of judder measured by the second judder counter;
a first operation unit to calculate a first variance of the first minimum values detected by the first minimum value detection unit;
a second operation unit to calculate a second variance of the second minimum values detected by the second minimum value detection unit; and
a judgment unit to judge whether the caption exists in the second field by comparing the first variance calculated by the first operation unit with the second variation calculated by the second operation unit.

4. The film mode detection apparatus as claimed in claim 3, wherein the caption detection unit further comprises:
a first buffer to store the first minimum values detected by the first minimum value detection unit; and
a second buffer to store the second minimum values detected by the second minimum value detection unit.

5. The film mode detection apparatus as claimed in claim 3, wherein the caption detection unit further comprises:
a caption area detection unit to detect a caption area among areas of the fields according to the judder detected by the judder detection unit.

6. The film mode detection apparatus as claimed in claim 3, wherein the first area comprises one of a whole field area including the caption area and the caption area of the fields, and the second area comprises a remaining field area excluding the caption area of the fields.

7. The film mode detection apparatus as claimed in claim 3, wherein the first and second variances each comprise one of an average, a standard deviation, and a dispersion of the respective first and second minimum values.

8. The film mode detection apparatus as claimed in claim 3, wherein when the difference between the first variance and the second variance is greater than a predetermined value, the judgment unit judges that the caption exists in the second field.

9. The film mode detection apparatus as claimed in claim 1, wherein the pattern generation unit generates the pattern in the remaining field area excluding the caption area if the caption is detected by the caption detection unit, and generates the pattern in a whole field area if the caption is not detected by the caption detection unit.

10. A film mode detection apparatus comprising:
a caption detection unit to detect minimum values of difference values of information between successive fields from a field area that includes a caption area and a remaining field area that excludes the caption area in an input image, respectively, and to judge whether a caption exists in a field according to variances of the detected minimum values;
a pattern generation unit to generate a pattern in a whole area of the field and by specified areas of the field using the difference values of the information between the successive fields; and
a decision unit to determine whether the input image is a film image using one of the patterns generated by the pattern generation unit according to a result of the judgment performed by the caption detection unit.

11. The film mode detection apparatus as claimed in claim 10, wherein the decision unit uses a pattern generated in the remaining field area excluding the caption area when the caption is detected by the caption detection unit, and the decision unit uses the pattern generated in the whole area of the field when the caption is not detected by the caption detection unit.

12. A film mode detection apparatus, comprising:
a caption detection unit to determine whether a caption exists in fields of an input image; and
a film image detection unit to determine whether the input image is a film image using a non-caption area of the fields of the input image not including the caption when the caption detection unit determines that the caption exists and using a total area of the fields of the input image when the caption detection unit determines that the caption does not exist.

13. The film mode detection apparatus as claimed in claim 12, wherein the film image detection unit comprises:
a pattern generating unit to generate a pattern according to difference values between successive fields of the input image in the non-caption area of the successive fields when the caption detection unit determines that the caption exists and to generate a pattern according to difference values between the successive fields of the input image in the total area of the successive fields when the caption detection unit determines that the caption does not exist; and
a decision unit to determine whether the input image is the film image according to the pattern generated by the pattern generating unit.

14. The film mode detection apparatus as claimed in claim 12, wherein the film image detection unit comprises:
a pattern generating unit to generate a plurality of patterns according to difference values between successive fields of the input image using a plurality of different areas of the successive fields; and
a decision unit to select one of the plurality of patterns corresponding to the non-caption area when the caption detection unit determines that the caption exists, to select one of the plurality of patterns corresponding to the total area when the caption detection unit determines that the caption does not exist, and to determine whether the input image is the film image according to the selected pattern.

15. The film mode detection apparatus as claimed in claim 12, wherein the caption detecting unit calculates first and second difference values between successive fields of the input image in a first area including a predetermined portion of the successive fields and a second area excluding the predetermined portion of the successive fields, respectively, and compares variances of the calculated first and second difference values to determined whether the caption exists within the predetermined portion of the successive fields.

16. The film mode detection apparatus as claimed in claim 12, wherein the caption detecting unit detects a caption area according to judder of the fields of the input image, calculates first and second minimum judder values between successive fields of the input image in a first area including the caption area of the successive fields and a second area excluding the caption area of the successive fields, respectively, and compares variances of the calculated first and second minimum judder values to determined whether the caption exists within the caption area.

17. A film mode detection method comprising:
detecting judder of fields of an input image;
measuring an amount of judder between a first field and a second field and an amount of judder between the second field and a third field in a first area and a second area of the fields, respectively;
detecting first minimum values of the amount of judder measured in the first area and second minimum values of the amount of judder measured in the second area;
calculating a first variance of the first minimum values and a second variance of the second minimum values;
judging whether a caption exists in the second field by comparing the first variance with the second variance;
generating a pattern using difference values of information between the successive fields according to whether the caption exists; and
judging whether the input image is a film image using the generated pattern.

18. The film mode detection method as claimed in claim 17, wherein the first area comprises one of a whole field area including a caption area and the caption area, and the second area comprises a remaining field area excluding the caption area.

19. The film mode detection method as claimed in claim 17, wherein the first variance and the second variance comprise one of an average, a standard deviation, and a dispersion of the first minimum values and the second minimum values, respectively.

20. The film mode detection method as claimed in claim 17, wherein the judging of whether the caption exists in the second field comprises:
judging that the caption exists in the second field when a difference between the first variance and the second variance is greater than a predetermined value.

21. The film mode detection method as claimed in claim 17, wherein the generating of the pattern using the difference values of the information between the successive fields comprises:
generating the pattern in a remaining area excluding a caption area if the caption is judged to exist; and
generating the pattern in a whole area of the field if the caption is judged not to exist.

22. The film mode detection method as claimed in claim 17, wherein the detecting of the judder of the fields comprises:
detecting a caption area using the detected judder detected.

23. The film mode detection method as claimed in claim 22, wherein the detecting of the caption area comprises:
detecting a specified area as the caption area when the detected judder is greater than a predetermined value in the specified area of the fields.

24. A film mode detection method comprising:
detecting judder of fields of an input image;
measuring an amount of judder between a first field and a second field and an amount of judder between the second field and a third field in a first area and a second area of the fields, respectively;
detecting first minimum values of the amount of judder measured in the first area and second minimum values of the amount of judder measured in the second area;
calculating a first variance of the first minimum values and a second variance of the second minimum values;
judging whether a caption exists in the second field by comparing the first variance with the second variance;
generating a pattern in a whole area of the field and by specified areas of the field using difference values of information between the successive fields; and
judging whether the input image is a film image using one of the generated patterns according to whether the caption is judged to exist.

25. The film mode detection method as claimed in claim 24, wherein the judging of whether the input image is the film image comprises:
using a pattern generated in a remaining area excluding a caption area when the caption is judged to exist, and using a pattern generated in the whole area of the field if the caption is judged not to exist.

26. A film mode detection method, comprising:
determining whether a caption exists in fields of an input image;
generating a pattern according to difference values between successive fields of the input image in a non-caption area of the successive fields not including the caption when the caption is determined to exist and generating a pattern according to difference values between successive fields of the input image in a total area of the successive fields when the caption is determined not to exist; and
determining whether the input image is a film image according to the generated pattern.

27. The film mode detection method as claimed in claim 26, wherein the determining of whether the caption exists comprises:
detecting judder in the fields of the input image;
calculating first and second minimum judder values between successive fields of the input image in a first area including a predetermined portion of the successive fields and a second area excluding the predetermined portion of the successive fields, respectively; and
comparing variances of the first and second minimum judder values to determine whether the caption exists in the predetermined portion of the successive fields.

28. The film mode detection method as claimed in claim 26, wherein the determining of whether the caption exists comprises:
detecting judder in the fields of the input image;
detecting a caption area of the fields according to the detected judder;
calculating first and second minimum judder values between successive fields of the input image in a first area of the successive fields including the caption area and a second area of the successive fields excluding the caption area, respectively; and
comparing variances of the first and second minimum judder values to determine whether the caption exists in the caption area of the successive fields.

29. The film mode detection method as claimed in claim 26, wherein the generating of the pattern comprises:
obtaining the difference values between the successive fields of the input image in one of the non-caption area and the total area; and
comparing the obtained difference values to a predetermined threshold value.

30. The film mode detection method as claimed in claim 26, wherein the determining of whether the input image is the film image comprises:
comparing the generated pattern to a predetermined film image pattern.

31. A film mode detection method, comprising:
determining whether a caption exists in fields of an input image; generating a plurality of patterns according to difference values between successive fields of the input image using a plurality of different areas of the successive fields; and
selecting one of the plurality of patterns corresponding to a non-caption area of the successive fields not including the caption when the caption is determined to exist and selecting one of the plurality of patterns corresponding to a total area of the successive fields when the caption is determined not to exist; and
determining whether the input image is the film image according to the selected pattern.

32. A film mode detection method, comprising:
determining whether a caption exists in fields of an input image; and
determining whether the input image is a film image using a non-caption area of the fields of the input image not including the caption when the caption is determined to exist and using a total area of the fields of the input image when the caption is determined not to exist.
